(19) United States
(12) Patent Application Publication
(10) Pub. No.: US 2023/0350391 A1
(43) Pub. Date: Nov. 2, 2023

(54) STRUCTURED DATA MODEL AND PROPAGATION THEREOF FOR CONTROL OF MANUFACTURING EQUIPMENT

(71) Applicant: Liveline Technologies Inc., Livonia, MI (US)

(72) Inventors: John James Burtenshaw, Tavistock (CA); Joseph Eugene Hernandez, Farmington Hills, MI (US); Sean Gregory Scott, Walled Lake, MI (US); Christopher Edward Couch, Ann Arbor, MI (US)

(21) Appl. No.: 18/308,853

(22) Filed: Apr. 28, 2023

Related U.S. Application Data
(60) Provisional application No. 63/336,597, filed on Apr. 29, 2022.

(51) Int. Cl. G05B 19/418

(52) U.S. Cl. CPC G05B 19/41815

(57) ABSTRACT

Following activation of a first machine, a standardized structured data model is instantiated in a controller of the first machine that describes the first machine according to predefined categories populated with predefined labels that are indicative of measured parameters of the first machine, components of the first machine, and subsystems of the first machine.

### CROSS-REFERENCE TO RELATED APPLICATION

This application claims the benefit of U.S. provisional application No. 63/336,597, filed Apr. 29, 2022, the entire contents of which is incorporated by reference herein.

### TECHNICAL FIELD

This disclosure relates to the control of manufacturing equipment.

### BACKGROUND

A manufacturing control system may respond to input signals and generate output signals that cause the equipment under control to operate in a particular manner.

### SUMMARY

A method includes, following activation of a first machine, instantiating in a controller of the first machine a standardized structured data model describing the first machine according to predefined categories populated with predefined labels that are indicative of measured parameters of the first machine, components of the first machine, and subsystems of the first machine. The predefined labels have a parent-child relationship defined by the predefined categories and in which the predefined labels indicative of the measured parameters are categorized by the predefined labels indicative of the components, and the predefined labels indicative of the components are categorized by the predefined labels indicative of the subsystems. The predefined categories and predefined labels correspond to categories and labels describing a second machine such that the parent-child relationship correlates to a parent-child relationship of the labels describing the second machine. The method also includes instantiating in the controller a version of a machine learning model trained on the second machine and in communication with the standardized structured data model, and controlling operation of the first machine according to output of the machine learning model.

### BRIEF DESCRIPTION OF THE DRAWINGS

FIGS. 1 and 2 are block diagrams of manufacturing systems.

### DETAILED DESCRIPTION

Embodiments are described herein. It is to be understood, however, that the disclosed embodiments are merely examples and other embodiments may take various and alternative forms. The figures are not necessarily to scale. Some features could be exaggerated or minimized to show details of particular components. Therefore, specific structural and functional details disclosed herein are not to be interpreted as limiting, but merely as a representative basis for teaching one skilled in the art.

Various features illustrated or described with reference to any one example may be combined with features illustrated or described in one or more other examples to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Standardized structured data models proposed herein enable one to model a manufacturing line and all of the machines on it. These models can be defined in a database. Use of the word “model” suggests that there is an ability to create a multi-level parent/child relationship of a machine and its properties. For example, given an extruder, a model of the same includes a screw, which has temperature control zones, a speed controller, etc. These properties of the machine may be important not only so that data can be collected and analyzed, but also to enable a common labeling language for use with other extruders. This could be helpful for creating software tools that can, continuing with this example, compare one extruder to another, report on capability/efficiency in a common way, and create machine learning models that can apply what is learned from one line to another. With regard to the latter, if it is discovered that when the temperature zone on a screw of one extruder increases, a corresponding change in product dimension occurs for that extruder. This insight can be used to increase the rate of learning for other extruders given that all are modeled in the same way.

The standardized structured modeling process is generally as follows. A user inputs the machines of a manufacturing line along with their properties into a database using a series of drop down boxes provided by a front end user interface to the database. The database model then instantiates these as objects in the database, thus now having the object definitions for all of the equipment on the line of interest. Once the modeling process is complete, the following are enabled. The architecture uses these instantiated object definitions to connect to the data sources and store data from them in a structured way, i.e., attaches data points to their appropriate machine properties. The storing of the data in this standardized structure enables standard reporting of machine efficiencies, anomaly detection, etc. As described more below, the machine learning process is also improved by using this strategy.

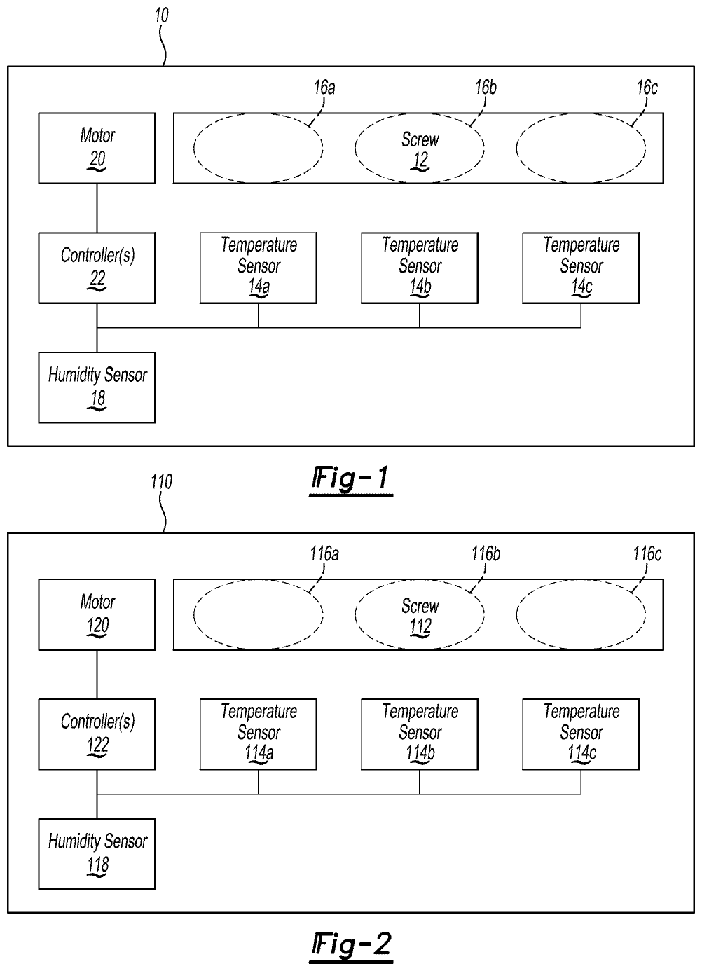

Referring to FIG. 1 and continuing with the example above, an extruder 10 may have a screw 12, several temperature sensors 14a, 14b, 14c corresponding to zones 16a, 16b, 16c, a humidity sensor 18, a motor 20, and a controller 22. Upon initial installation, a standardized structured data model of the extruder 10 can be constructed. The table below illustrates one such possibility. To facilitate ease of discussion, this example contains relatively few categories and labels. The ideas conveyed, however, can be applied to more complicated environments having hundreds, if not thousands, of categories and labels.

TABLE 1

| Abstractions | Components | Features |
|---|---|---|
| Driver (key | Motor 20 (active driver) | RPM (1000 to 1150), Power Consumption |
| data) | | (correlated with Change in Temperature) |
| Mechanism | Screw 12 (active driver) | RPM (200 to 300) |
| Region 1 | Temperature Sensor 14a (sensor) | Temperature (influenced by Motor 20), |
| | | Change in Temperature |
| | Zone 16a (key data) | Temperature, Change in Temperature |
| | Humidity Sensor 18 (sensor) | Humidity (<80%) |
| Region 2 | Temperature Sensor 14b (sensor) | Temperature, Change in Temperature |
| | Zone 16b | Temperature, Change in Temperature |
| | Humidity Sensor 18 (sensor) | Humidity (<80%) |
| Region 3 | Temperature Sensor 14c (sensor) | Temperature, Change in Temperature |
| | Zone 16c | Temperature, Change in Temperature |
| | Humidity Sensor 18 (sensor) | Humidity (<80%) |

In this example, three categories are used to characterize the extruder 10: Abstractions, Components, and Features. Features (measured parameters in this example) belong to Components in a parent/child relationship, Components belong to Abstractions (subsystems in this example) in a parent/child relationship, and by extension Features belong to Abstractions. The Abstractions category, as the name suggests, characterizes the extruder 10 at a more conceptual level. The Components category characterizes the extruder 10 by its actual devices, as grouped according to the corresponding abstraction. The numbered elements of FIG. 1 are thus assigned to the Components category. As such, a single or several components can belong to an identified member of the Abstractions category. The “Mechanism” abstraction, for example, includes only the screw 12, whereas the “Region 1” abstraction includes the temperature sensor 14a, zone 16a, and humidity sensor 18. A same component can thus belong to more than one identified abstraction. The humidity sensor 18, for example, belongs to each of the “Region 1,” Region 2,” and “Region 3” abstractions. As discussed more below, use of the Abstractions category in addition to the Components category may facilitate faster machine learning.

The Features category characterizes the extruder 10 according to measurable parameters, as grouped according to the corresponding component. A single feature or multiple features can be used to describe a particular component. Measured RPM of the screw 12, for example, is used to describe the screw 12, whereas measured temperature and change in temperature are used to describe the zone 16a.

The labels, in this example, also include other contextual information that further aid in accelerating the machine learning process because this information does not need to be learned from training data. Some of the feature labels identify acceptable range of operation data and/or whether signals associated with the same are correlated. The feature “RPM” belonging to “Motor 20” indicates an acceptable range of operation of 1000 rpm to 1150 rpm. The feature “Power Consumption” belonging to “Motor 20” indicates that its signal values are correlated with “Change in Temperature” signal values. The feature “Temperature” belonging to “Temperature Sensor 14a” indicates that its signal values are influenced by activity of “Motor 20.” The feature “Humidity” belonging to each of “Region 1,” “Region 2,” and “Region 3” indicates an acceptable range of less than 80% relative humidity. Some of the component labels include identifiers indicating whether a device associated with a particular component label is a sensor or an active driver. “Screw 12” is identified as an active driver, whereas “Temperature Sensor 14a” is identified as a sensor. Some of the labels include markers indicating that data corresponding therewith should necessarily be included when creating training data sets. The abstraction label “Driver” is marked as being associated with key data (e.g., data from “Motor 20” in the form of “RPM” and “Power Consumption.”) The component label “Zone 16a” is similarly marked. Contextual information need not be limited to the examples here. Any relevant information may thus be included when constructing labels.

The mappings detailed by Table 1, including the contextual information, can be strategically created by one or more users based on experience and other factors. And in contrast to existing mapping strategies, the concept of abstractions and contextual information is introduced via Table 1. This, as mentioned above, can increase machine learning rate as the collective relevance of temperature sensor, zone, and humidity sensor, captured in terms of the abstraction “Region,” need not be learned during the training phase. For example, to the extent measured parameters associated with the temperature sensor, zone, and humidity sensor collectively express a pattern of behavior under certain conditions that correlate with and/or impact performance of the extruder 10, training time and training data are not necessary to recognize such correlation and/or impact as it is already predefined. The same is true of the contextual information, etc.

Still further, if a second extruder were later introduced, either at a same or different manufacturing facility, and conventional techniques were used to create a model of the extruder for machine learning purposes, that model might be created on an ad-hoc basis with no regard for the model of Table 1 describing the extruder 10. Under such circumstances and even though both of the extruders are the same, that which is machine learned about the extruder 10 cannot be easily applied/transferred to the second extruder because the underlying mappings used to describe each are not the same.

Leveraging the concept of the standardized structured data model described above and continuing with the example, mappings corresponding to those used to describe the extruder 10 are used to describe the second extruder. Referring to FIG. 2, an extruder 110 includes a screw 112, several temperature sensors 114a, 114b, 114c corresponding to zones 116a, 116b, 116c, a humidity sensor 118, a motor 120, and a controller 122. Table 2 illustrates that the mappings (and thus parent/child relationships) and contextual information for the extruder 110 correlate to those for the extruder 10. In this example they are the same, but need not be (and need not be one to one) provided the correspondence is clear.

TABLE 2

| Abstractions | Components | Features |
|---|---|---|
| Driver (key | Motor 120 (active driver) | RPM (1000 to 1150), Power Consumption |
| data) | | (correlated with Change in Temperature) |
| Mechanism | Screw 112 (active driver) | RPM (200 to 300) |
| Region 1 | Temperature Sensor 114a (sensor) | Temperature (influenced by Motor 120), |
| | | Change in Temperature |
| | Zone 116a (key data) | Temperature, Change in Temperature |
| | Humidity Sensor 118 (sensor) | Humidity (<80%) |
| Region 2 | Temperature Sensor 114b (sensor) | Temperature, Change in Temperature |
| | Zone 116b | Temperature, Change in Temperature |
| | Humidity Sensor 118 (sensor) | Humidity (<80%) |
| Region 3 | Temperature Sensor 114c (sensor) | Temperature, Change in Temperature |
| | Zone 116c | Temperature, Change in Temperature |
| | Humidity Sensor 118 (sensor) | Humidity (<80%) |

When applying machine learning in the manufacturing context, a template physics model for the machine in question is typically selected and then trained with training data before use in control of the machine. Training of the template model, among other things, results in the weighting factors between nodes being altered so the template model better performs against the training data (and production data). Training of the template model can thus be data and time intensive. If the data models between the same machines are different (as is typically the case when generated in an ad-hoc fashion), the respective physics models linked with the corresponding data models each must experience the data and time intensive training phase as the physics model of one cannot be directly applied to the other.

Here it is suggested that, when data models (such as those of Tables 1 and 2) of machines are standardized, a second machine can be initialized with a version of a trained physics model of a first machine—drastically shortening the training phase of the physics model of the second machine. This is because aspects of the machine learning tied to the second machine itself need only be learned once by the first machine, leaving the remaining training for learning about the unique environment of the second machine and the effect on its operation. Thus, the controller 122 can be instantiated with a version of a machine learning model trained on the extruder 10 so as to be in communication with the standardized structured data model of Table 2 such that the machine learning model, among other things, is informed of the parent/child relationships captured therein and the contextual information provided thereby (e.g., the machine learning model has access to the information held by the standardized structured data model, etc.).

The machine learning model of the controller 122 may then generate predicted parameter values associated with parts output by the extruder 110 based on a live streaming feature set derived via pre-processing (e.g., data cleansing, principal component analysis, etc.) of live data that includes output from the temperature sensors 114a, 114b, 114c, humidity sensor 118, and motor 120. The controller 122 may further direct control actions to the extruder 110 (e.g., the motor 120) based on the predicted parameter values to change control settings (e.g., RPM setting, power consumption settings, etc.) to keep the predicted feature parameter values, and thus actual values, at or near their targets.

Given the extruders 10, 110 are of the same configuration, have the same standardized structured data models, and have versions of the same machine learning model that share a common training history (each in communication with its corresponding one of the same structured data models), control aspects learned with respect to one of the extruders 10, 110 can be applied to the other of the extruders 10, 110. If, for example, it is learned with respect to the extruder 10 that a particular combination of RPM for the screw 12 and temperature in the zone 16b, as detected by the temperature sensor 14b, results in a property of components produced by the extruder 10 being out of its target range (e.g., component length is greater than a target length) only when relative humidity, as detected by the humidity sensor 18, is greater than some threshold value (e.g., 70%), and that reducing power consumption of the motor 20 by 15% during presence of such conditions returns the property to its target range, the controller 22 may communicate control settings reflecting the same to the controller 122, which may be at the same or another location or facility. The controller 122 may automatically implement these received settings when the specified conditions occur to control the extruder 110 and avoid component parameters falling outside the target ranges. Moreover, given the extruders 10, 110 have the same standardized structured data models, analyzing, comparing, reporting, and visualizing data related to the same may be more efficient as compared with extruders having different structured data models.

The algorithms, methods, or processes disclosed herein can be deliverable to or implemented by a computer, controller, or processing device, which can include any dedicated electronic control unit or programmable electronic control unit. Similarly, the algorithms, methods, or processes can be stored as data and instructions executable by a computer or controller in many forms including, but not limited to, information permanently stored on non-writable storage media such as read only memory devices and information alterably stored on writeable storage media such as compact discs, random access memory devices, or other magnetic and optical media. The algorithms, methods, or processes can also be implemented in software executable objects. Alternatively, the algorithms, methods, or processes can be embodied in whole or in part using suitable hardware components, such as application specific integrated circuits, field-programmable gate arrays, state machines, or other hardware components or devices, or a combination of firmware, hardware, and software components.

While exemplary embodiments are described above, it is not intended that these embodiments describe all possible forms encompassed by the claims. The words used in the specification are words of description rather than limitation, and it is understood that various changes may be made without departing from the spirit and scope of the disclosure. The words controller and controllers, for example, may be used interchangeably herein.

As previously described, the features of various embodiments may be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics may be compromised to achieve desired overall system attributes, which depend on the specific application and implementation. These attributes may include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and may be desirable for particular applications.

What is claimed is:

1. A method comprising:
following activation of a first machine, instantiating in a controller of the first machine a standardized structured data model describing the first machine according to predefined categories populated with predefined labels that are indicative of measured parameters of the first machine, components of the first machine, and subsystems of the first machine, wherein the predefined labels have a parent-child relationship defined by the predefined categories and in which the predefined labels indicative of the measured parameters are categorized by the predefined labels indicative of the components, and the predefined labels indicative of the components are categorized by the predefined labels indicative of the subsystems, and wherein the predefined categories and predefined labels correspond to categories and labels describing a second machine such that the parent-child relationship correlates to a parent-child relationship of the labels describing the second machine;
instantiating in the controller a version of a machine learning model trained on the second machine and in communication with the standardized structured data model; and
controlling operation of the first machine according to output of the machine learning model.

2. The method of claim 1 further comprising receiving data from the second machine defining settings for the second machine and updating the version of the machine learning model with the data such that the controller implements the settings.

3. The method of claim 1, wherein some of the predefined labels include information defining a range of target values for a corresponding one or more of the measured parameters.

4. The method of claim 1, wherein some of the predefined labels include information indicating corresponding signals are correlated.

5. The method of claim 1, wherein some of the predefined labels include information indicating corresponding signal values are affected by operation of at least one of the components.

6. The method of claim 1, wherein some of the predefined labels include information identifying whether a corresponding one or more of the components are sensors.

7. The method of claim 1, wherein some of the predefined labels include information identifying whether corresponding data should be included in data sets used for training of machine learning models.

8. The method of claim 1, wherein a plurality of the predefined labels indicative of the measured parameters is categorized according to one of the predefined labels indicative of the components.

9. The method of claim 1, wherein one of the predefined labels indicative of the measured parameters is categorized by a plurality of the predefined labels indicative of the components.

10. The method of claim 1, wherein a plurality of the predefined labels indicative of the components is categorized according to one of the predefined labels indicative of the subsystems.
